(19) United States
(12) Patent Application Publication
(10) Pub. No.: US 2014/0365016 A1
(43) Pub. Date: Dec. 11, 2014

(54) Controlling the Heating of Rooms

(71) Applicant: BMSHome Limited, Durham (GB)

(72) Inventors: Michael John Hartley, Sunderland (GB); Anthony David Gair, sunderland (GB)

(21) Appl. No.: 13/912,247

(22) Filed: Jun. 7, 2013

(30) Foreign Application Priority Data
Jun. 7, 2013 (GB) 12 10 104.4

(51) Int. Cl. G05B 15/02

(52) U.S. Cl. CPC G05B 15/02
USPC 700/276

(57) ABSTRACT

In a building, electric storage heaters (204) receive off peak electricity, generate thermal energy and store this thermal energy for later release. Each storage heater has a local control device (201) for controlling thermal energy generated during the reception of the off peak electricity. Each local control device receives a generation schedule from a building control device (207). Each building control device controls many local control devices and transmits information to a central control device (208). The central control device transmits generation schedules to many building control devices. Each schedule is constructed in response to room related data supplied by the local control devices, building related data supplied by the building control devices and regional data supplied to the central control device.

### CROSS REFERENCE TO RELATED APPLICATIONS

This application represents the first application for a patent directed towards the invention and the subject matter.

### BACKGROUND OF THE INVENTION

1. Field of the Invention

The present invention relates to apparatus for heating a plurality of rooms in a plurality of buildings. The present invention also relates to a method of controlling the amount of electrical energy supplied to electric storage heaters, an electric storage heater and a local control device for an electric storage heater.

2. Description of the Related Art

Storage heaters are known that include electrical heating elements embedded within a heat storage material. They are usually used with a two-tariff electricity meter that records separately the electricity used during peak and off peak periods. Heat generated during off peak periods is then released when required. The extent to which heat is released may be controlled by the opening of louvers and by the activation of an internal fan. Conventional storage heaters will therefore usually have two controls, a first being referred to as a charge control or input control that controls the amount of heat stored and the second being referred to as a draft control or output control that controls the rate at which the heat is released. In known systems, the draft control may be operated in response to a thermostat. However, actual energy consumption is controlled by the input control which in most applications relies upon manual operation. A problem therefore exists in that, in many applications, opportunities for saving energy are lost due to non-optimised manual operation.

### BRIEF SUMMARY OF THE INVENTION

According to a first aspect of the present invention, there is provided apparatus for heating a plurality of rooms in a plurality of buildings, comprising: a plurality of electric storage heaters configured to receive off peak electricity, generate thermal energy and store said thermal energy for later release; wherein each said electric storage heater has a local control device configured to control thermal energy generation during the reception of said off peak electricity, and to receive a generation schedule from a building control device, wherein said building control device is configured to control a plurality of local control devices and to transmit information to a central control unit; and said central control device is configured to transmit generation schedules to a plurality of building control devices, wherein each said schedule is constructed in response to room related data supplied to said local control devices, building related data supplied to said building control devices and regional data supplied to said central control device.

In an embodiment, a local control device receives local temperature data. Said temperature data may represent the temperature of heat storage material and/or said temperature data may represent room temperature.

According to a second aspect of the present invention, there is provided a method of controlling the amount of electrical energy supplied to electric storage heaters, comprising the steps of: connecting each electric storage heater to a local control device; supplying local data from each of a plurality of local control devises to a building control device; conveying local data and building data from one or more building control devices to a central control device; receiving regional data at said central control device; transmitting schedules of activation from said central control device to said one or more building control devices; and relaying individual activation schedules from said one or more building control devices to each of said local control devices, wherein each said schedule is constructed in response to room related data supplied from respective local control devices, building related data supplied from building control devices, and regional data supplied to said central control device.

In an embodiment, schedules are transmitted from the central control device to one or more building control devices for a plurality of days and individual activation schedules are relayed on a day by day basis.

In an embodiment, electric storage heater internal temperatures are analysed by said central control device in order to identify maximum heat capacities.

According to a third aspect of the present invention, there is provided an electric storage heater configured to receive off peak electricity, comprising: an electric heater energised via a local control device in response to a generation schedule; a heat storage material having a temperature sensor; an insulated housing for retaining said heat storage material; and a controllable opening for adjusting heat output, wherein said local control device supplies local data to a building controller; said local controller conveys local data from a plurality of local control devices and building data to a central control device; said central control device receives regional data and transmits schedules of activation to one or more building control devices; and said building control device relays individual activation schedules to the local control device.

According to a fourth aspect of the present invention, there is provided a local control device for an electric storage heater, comprising: a first output for supplying heating electricity to an electric storage heater; a second output for controlling the release of stored heat from said electric storage heater; and an input for receiving data defining a heat generation schedule.

### BRIEF DESCRIPTION OF THE DRAWINGS

FIG. 1 shows an electric storage heater;

FIG. 2 shows apparatus for heating a plurality of rooms;

FIG. 3 illustrates a method of controlling the amount of electrical energy supplied to electric storage heaters;

FIG. 4 illustrates an example of a data packet;

FIG. 5 details a local control device;

FIG. 6 shows procedures performed by the local control device detailed in FIG. 5;

FIG. 7 shows procedures performed by a building control device; and

FIG. 8 illustrates procedures performed by a central control device.

### DETAILED DESCRIPTION OF EXAMPLE EMBODIMENTS

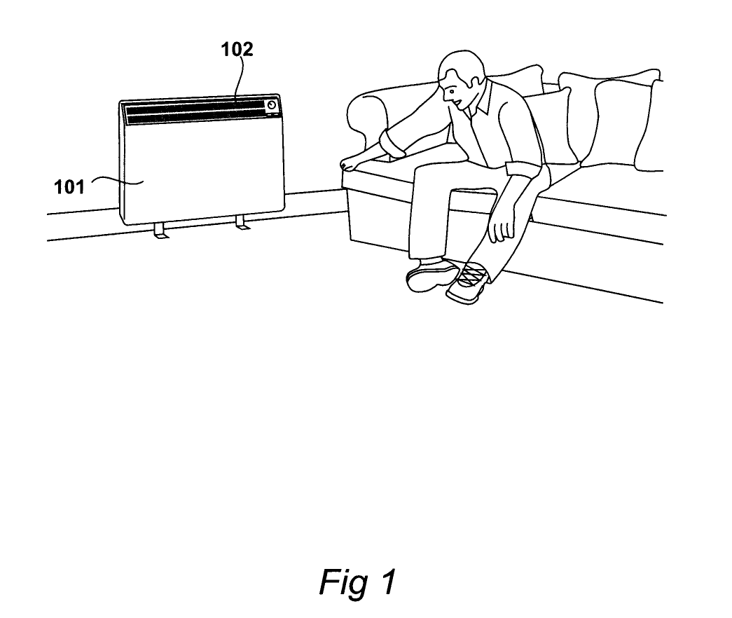

### FIG. 1

An electric storage heater 101 is shown in FIG. 1, configured to receive off peak electricity. An electric heater is energised via a local control device in response to a generation schedule. The heater includes an insulated housing for retaining heat storage material and a controllable opening 102 for facilitating heat output. The local control device supplies local data to a building controller. The building controller conveys local data from a plurality of local control devices along with building data to a central control device. The central control device receives regional data and transmits schedules of activation to one or more building control devices. The building control devices relay individual activation schedules to the local control devices.

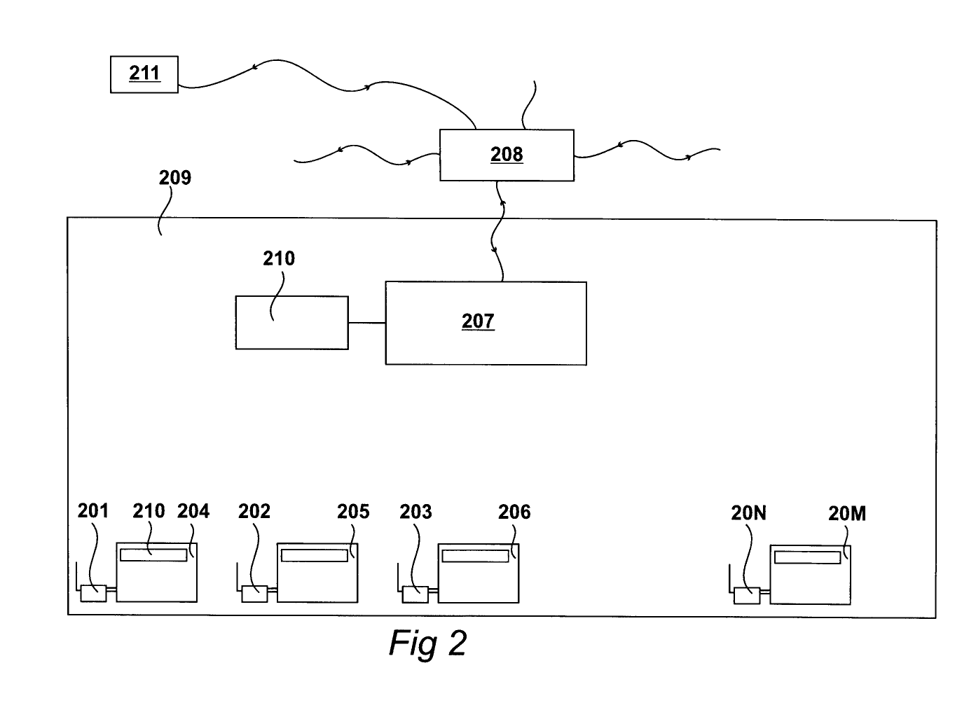

### FIG. 2

Apparatus for heating a plurality of rooms in a plurality of buildings is illustrated in FIG. 2. Local control devices may be included within an electric storage heater, as illustrated in FIG. 1, or the local control devices may be retro-fitted to existing storage heaters, as illustrated in FIG. 2. For the purposes of illustration, there is shown a first local control device 201, a second local control device 202, a third local control device 203 and so on until the final local control device within the building is identified as 20N. Thus, in this example, local control device 201 controls heater 204, local control device 202 controls heater 205, local control device 203 controls heater 206 and so on until local control device 20N is shown controlling heater 20M. Thus, each of the plurality of electric storage heaters (204 to 20M) is configured to receive off peak electricity, generate thermal energy and store said thermal energy for later release.

Each local control device is configured to control thermal energy generation during the reception of off peak electricity. Furthermore, each local control device is also configured to receive a generation schedule from a building control device 207.

A central control device 208 is configured to transmit generation schedules to a plurality of building control devices, including building control device 207. Each schedule is constructed in response to room related data supplied to the local control devices, such as device 201, building related data supplied to the building control devices, such as device 207 and regional data supplied to the central control device 208.

The building control device 207 is shown within a building 209. Within the building, heaters 204 to 20M are appropriately situated and in domestic applications for example, building 209 will be divided into a plurality of dwellings each made up of a plurality of rooms.

Each storage heater, such as heater 204, includes a mechanism 210 for releasing the stored thermal energy and operation of an opening device of this type is controlled by the local control device 201. Furthermore, in an embodiment, the release of stored energy is also facilitated by the activation of an active fan.

In an embodiment, the local control devices 201 to 20N receive local temperature data. The temperature data may represent the temperature of the heat storage material contained within the respective storage heater. Alternatively, or in addition, temperature data may include an indication of room temperature.

The apparatus may be deployed in a traditional tower block in which, for example, a twenty storey tower may have six apartments per storey giving a total of one hundred and twenty dwellings; typically each having four storage heaters. Within the total system, handsets and controllers may also be included such that there could be a total of six hundred to eight hundred devices within the tower block requiring channels of communication.

The electric storage heaters are usually hardwired into a separate off peak tariff circuit (usually identified as “economy 7” in the United Kingdom) and the local control device 201, in the embodiment of FIG. 2, is installed inline. Thus, power enters the local control device 201 and is then passed on to the electric storage heater 204.

Wireless communication is provided between each local control device 201 and the building control device 207. A wireless network may, for example, adopt Zigbee or Jennic protocols, such that addressed packets of data may be transmitted from the local control devices 201 etc to the building control device 207 and similarly addressed packets of data (charging schedules) may be transmitted from the building control device 207 to each individual local device 201 to 20N.

Examples of transmitted local data, that is data supplied from each individual local control device to the building control device 207, may include static values and dynamic values. Static values may relate to the nature of the room itself that is to say, whether the room is on a north facing or south facing wall for example and, in a tower block, the actual height of the room given that higher apartments will experience greater heat loss due to increased wind strength.

Dynamic local values will include brick temperature (within the heater), room temperature, and energy delivery, from which it is possible to determine the extent to which energy has been retained by the heater prior to the start of the next charging cycle. The dynamic data may also include the ability to detect motion from which it is possible to predict usage patterns, thereby allowing the system to adapt to providing heat only for times when rooms are occupied.

The apparatus of FIG. 2 also includes building wide detectors 210 that may provide information identifying external variables, such as temperature and the external wind speed. These may be added to static data for the building as a whole identifying the position of the building, that is the extent to which the building is exposed, along with inherent properties of the building such as the effectiveness of its insulation. Thus, building related data is supplied to the building control devices 207. Furthermore, regional data from a source 211 is supplied to the central control device 208. This may include dynamic data, such as weather reports and static data such as that specifying tariffs: these being the intervals during the day during which it is possible to obtain off peak electricity. Thus, building related data may identify properties of the heating and heat retention for regions of the building. In addition, or as an alternative, the building related data may identify heating and heating retention properties for the building as a whole. The regional data, supplied to the central control device may be weather related data.

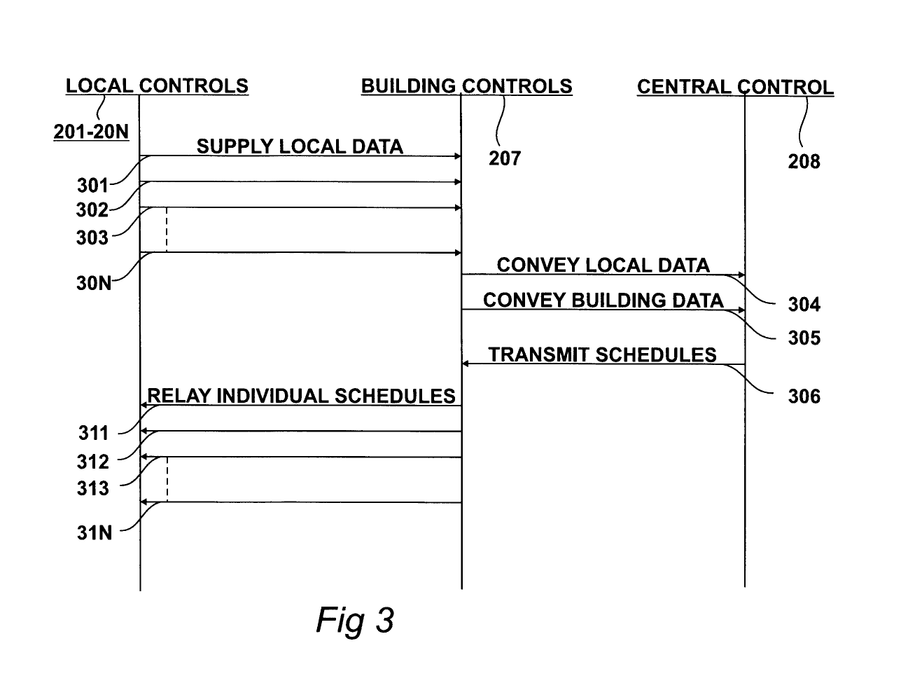

### FIG. 3

A method of controlling the amount of electrical energy supplied to electric storage heaters is illustrated in FIG. 3, in the form of a protocol diagram. Each electric storage heater 204, 205 etc is connected to a local control device 201, 202, 203 to 20N. Local data is supplied from each of the local control devices to a building control device 207. Thus, a transfer of local data from local control device 201 to the building control device 207 is shown at 301. A transfer of local data from local control device 202 to the building control device 207 is shown at 302, a transfer of local data from local control device 203 to the building control device 207 is shown at 302 and so on until a transfer of local data from local control device 20N to the building control device 207 is shown at 30N.

The local data received by the building control device 207 is conveyed to the central control device 208 as illustrated at 304. In addition, building related data is also conveyed to the central control device 208 as illustrated at 305. As previously described, this may include external temperature measurements and external wind speed measurements.

Regional data is received at the central control device 208, as illustrated in FIG. 2 and, from all of this received data, generation schedules are calculated at the central control device 208 for all of the electric heaters within the system. Thereafter, schedules are transmitted from the central control device 208 to each of the building control devices within the system. For the purposes of illustration, schedule data 306 is shown being transmitted from the central control device 208 to the building control device 207.

At a building control device, such as device 207, each of the individual schedules is relayed to their respective local control devices. Thus, for the purposes of illustration, schedule data 311 is relayed to local control device 201, schedule 312 is relayed to local control device 202, schedule 313 is relayed to local control device 203 and so on until schedule 31N is relayed to local control device 20N.

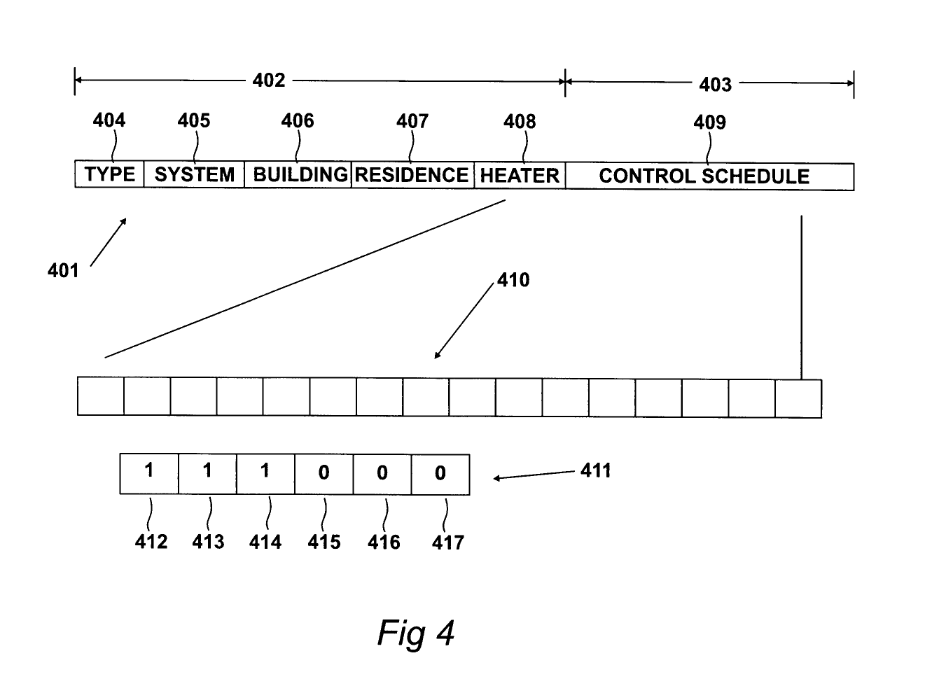

### FIG. 4

The protocols used within the environment of FIG. 2 facilitate the distribution of data in the form of packets. As shown in FIG. 4, a data packet 401 may consist of an address portion 402 and a content portion 403. In an embodiment, the address portion may identify the packet type 404, a particular system 405, a building 406, a residence 407 and a specific heater 408. The content portion 403 may include a control schedule 409. In this example, the control schedule 409 represents the data required for controlling the heaters over a twenty-four hour period. Thus, the control schedule 409 is divided into twenty-four hours, as shown at 410. Each hour is then divided into a ten minute interval, as illustrated at 411. For each ten minute interval a binary digit 412 is allocated specifying whether heat is to be generated, that is to say that the heater is to be energised, or whether the energisation is to be removed. In this example, a switching off transition occurs with binary digits 412, 413 and 414 representing a power on condition and binary digits 415, 416 and 417 representing a power off condition. When being handled within higher level applications, these binary strings may be processed as hexadecimal strings.

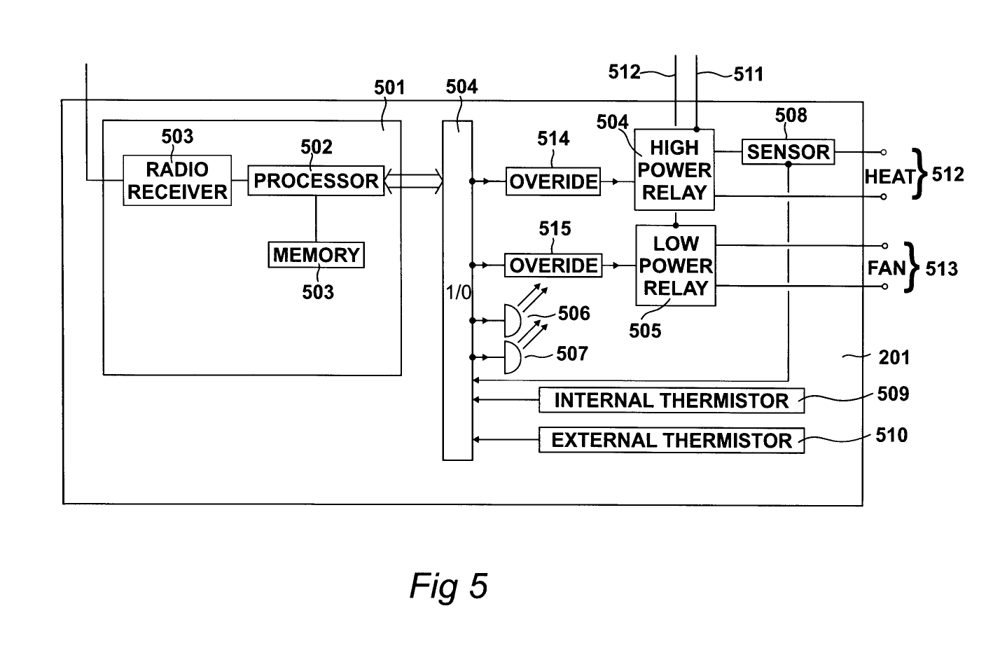

### FIG. 5

Local control device 201 is detailed in FIG. 5. A single integrated circuit 501 provides a processor 502, a radio receiver 503 and a non-volatile memory device 503, possibly implemented as flash memory. The processor of 502 communicates with an input/output device 504. The input/output device 504 energises a high power relay 504, a low power relay 505 a first illumination device 506 (such as a light-emitting diode) and a second illuminating device 507. The device 504 also receives input signals from a current sensor 508, an internal thermistor 509 and an external thermistor 510.

The high power relay 504 receives electrical energy from an off-peak supply 511 such that off-peak electricity may be conveyed to the heating elements of the electric heater via output power connections 512. Current sensor 508 monitors the level of current being supplied as input energy such that this data may be retained periodically within memory 503 and then supplied as local data to the building control device 207.

Low power relay 505 receives electrical power from a standard supply 512 so has to provide output power 513 to a fan contained within the heater 204. Thus, high power relay 504 is activated during the input or charging period and low power relay 505 is activated during the output or heat discharge period. A first override circuit 514 overrides the operation of the high power relay and a second override circuit 515 overrides the operation of the low power relay 505. When the override circuits 514 and 515 are active, the operation of the local control device is effectively disabled and the electric storage heater operates in its conventional manual way. Thus, this disabled condition may be desirable if network communications have been lost or if for whatever reason the schedule has not been updated. It is also possible for a resident to manually override the control system but such a manual override condition is monitored and data is supplied as local data to the building control device 207 when this occurs.

The first illuminating device 506 is illuminated when power is being received from the off-peak source 511 and the second illuminating device 507 is illuminated when communication is taking place with the network, that is to say, when local data is being supplied to the building control device or when schedules are being relayed from the building control device 207. In an embodiment, if communication is lost for more than one minute, the first override switch 514 is activated so as to ensure that power is maintained to the electric storage heater.

The monitoring of the internal temperature by the internal thermister 509 and the monitoring of the external temperature by the external thermister 510 allows the characteristics of the respective electric storage heater to be determined. As soon as heat is applied to an electric storage heater, an amount of heat will be lost. The amount of heat lost may be enhanced by opening louvers and activating the internal fan but at other times there may be a degree of heat wastage. However, it is also undesirable for there to be insufficient heat when required. Consequently, in an optimised system, input energisation is applied for a period of time that is just sufficient to provide the desired level of heating during the heat output period. If at the start of the input heat generation period, heat remains within the electric heating device, a short term solution may be to modify the extent to which the device is heated over the next charging period. However, over a longer term, further refinements may be made to the heating schedule so as to attempt to approach an optimised heating cycle, providing the required level of heat while avoiding any unnecessary heating operations and thereby optimising overall efficiency.

In an embodiment all calculations performed in order to optimise heating schedules are performed at the central control device 208. It is known that the heat storage materials, often in the form of ceramic bricks for example, can become fully heat soaked. A procedure may be included at the central control device 208 to determine the heat soak threshold for each electric storage heater within the system, of which there could be thousands. Thus, the heater could be charged for a full seven hours but measurements could then reveal that the bricks have not been getting any hotter for the last half hour. Thus, on the next cycle, the heating time may be reduced to 6.8 hours, then 6.5 hours etc to check whether it is possible to obtain the maximum temperature but for a lower charging period. Over time, further iterations may be performed in order to identify an optimum heat soak point thus saving energy that would otherwise be lost to atmosphere during the input cycle rather than being released during the output cycle.

An embodiment has been described in which motion detectors are also included in order to predict days during which rooms are not used and therefore can be left without heat. It should also be noted that the provision of motion detectors could also assist with fire rescue issues and other emergencies. For a building on fire with people present, information could be made available from the motion detectors as to whether someone has been present in a particular dwelling. Thus, even in situations where the motion detectors have become inactive, it would still be possible to review recently accumulated historical data.

In situations where rooms are identified as being unused, an embodiment may provide handheld units for overriding the operation of the system. Furthermore, these handheld units could include thermostats that could be used to control output levels or override the automated operation. However, in the absence of these override conditions, the system may analyse activity patterns and dynamically reconfigure heating schedules in order to gain maximum benefit from the energy being used.

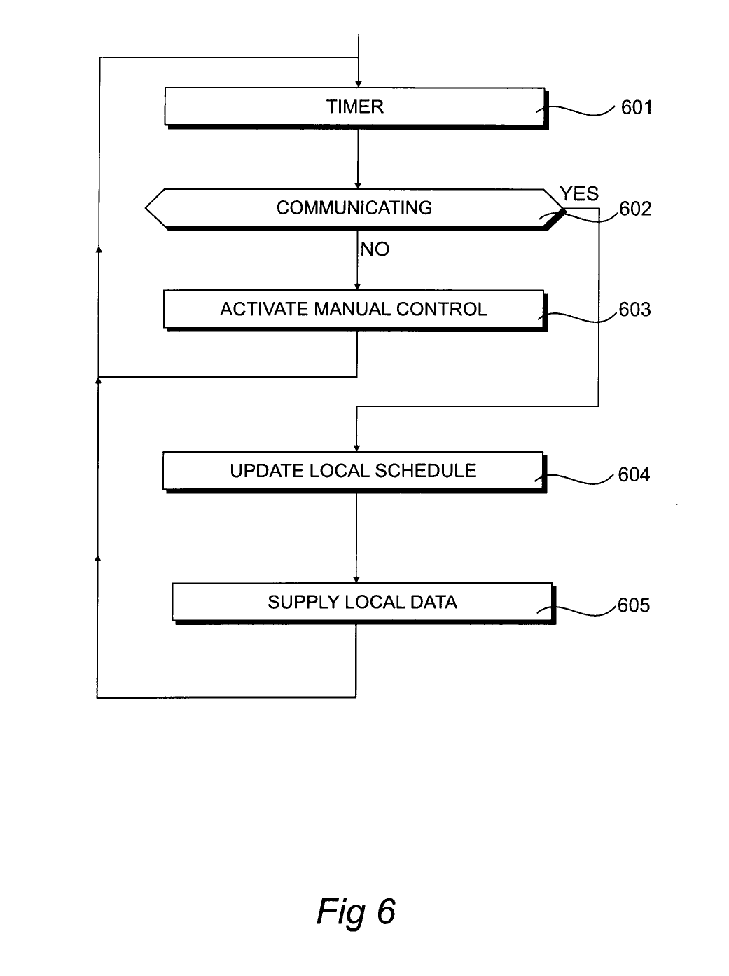

### FIG. 6

Procedures performed by processor 502 are shown in FIG. 6. At step 601 there is a watchdog timer which will periodically activate to determine whether communication is still possible and, if required, perform communication activities. Thus, after activation of watchdog timer 601, a question is asked at step 602 as to whether communication is possible. If answered in the negative, override switch 514 is activated so as to allow manual control of the local electric storage heater.

If the question asked at step 602 is answered in the affirmative, the local control device becomes receptive to communication in the network or receptive to receiving an interrupt from the building control device 207. Thus, at step 604 a local schedule is updated in response to receiving a relayed individual schedule from the building control device 207.

Thereafter, at step 605 local data is supplied to the building control device 207.

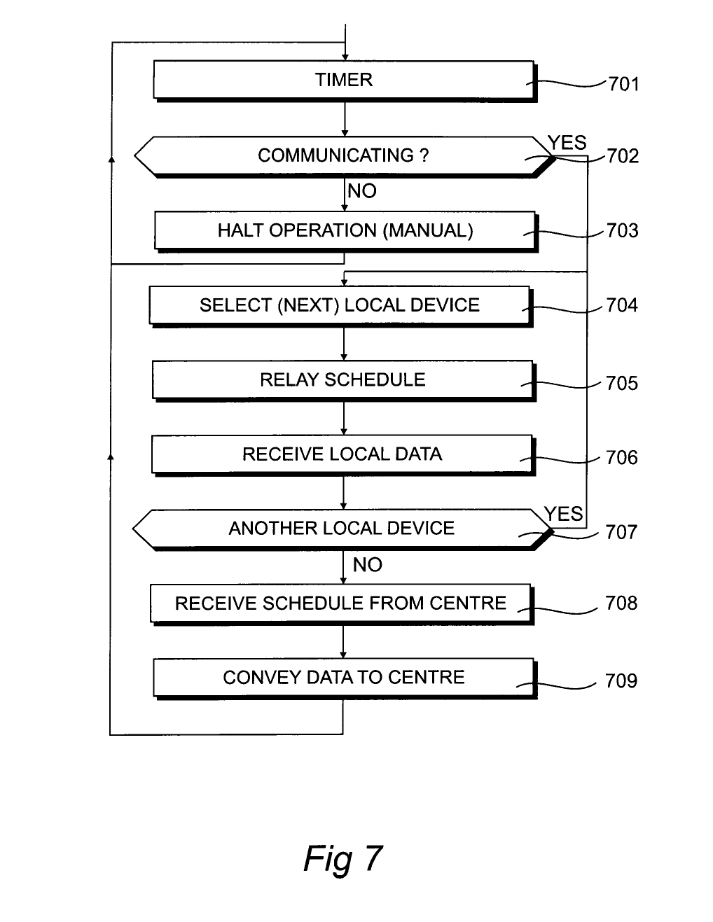

### FIG. 7

Procedures performed by the building control device 207 are shown in FIG. 7. In an embodiment, the building control device runs ladder table type logic, effectively running in a loop. A watchdog timer 701 is reset on each cycle. The building control device goes through a communication cycle, followed by a store cycle so as to hold data at the intermediate building level. The building control device then goes through an action cycle followed by a measurement cycle and a report cycle.

At step 702 a question is asked as to whether communication is taking place, in response to being activated by the watchdog timer and if answered in the negative operation is halted at step 703. Thus, this represents a manual operation condition that will be detected by each of the local control devices.

At step 704 the first local device 201 is selected. The schedule, transmitted from the central control device 208 is relayed from a building control device 207 to the selected local control device 201.

At step 706 local data cached at the selected local control device 201 is received by the building control device 207. Thereafter, at step 707 a question is asked as to whether another local control device is to be considered. On the first iteration, this question will be answered in the affirmative and the next local control device 202 will be selected at step 704. Thus, this process continues for all of the local control devices, up to local control device 20N.

At step 708 the building control device 207 receives further scheduled data transmitted from the central control device 208. Thereafter, at step 709 previously received local and building level data is conveyed to the central control device 208.

In an embodiment, the application previously described interfaces with the communications infrastructure provided by integrated circuit 501. Thus, in device 501 there is a physical layer for the radio infrastructure and a Zigbee or Jennic protocol operates on top of this.

In an embodiment, data packets or strings of data are transmitted within the radio network within the building. In an implementation, a process takes each message and places it in a buffer to be considered by an appropriate controller. When not handling an incoming or outgoing message, a process will consider previously cached messages due to go out to an address on the Zigbee/Jennic network.

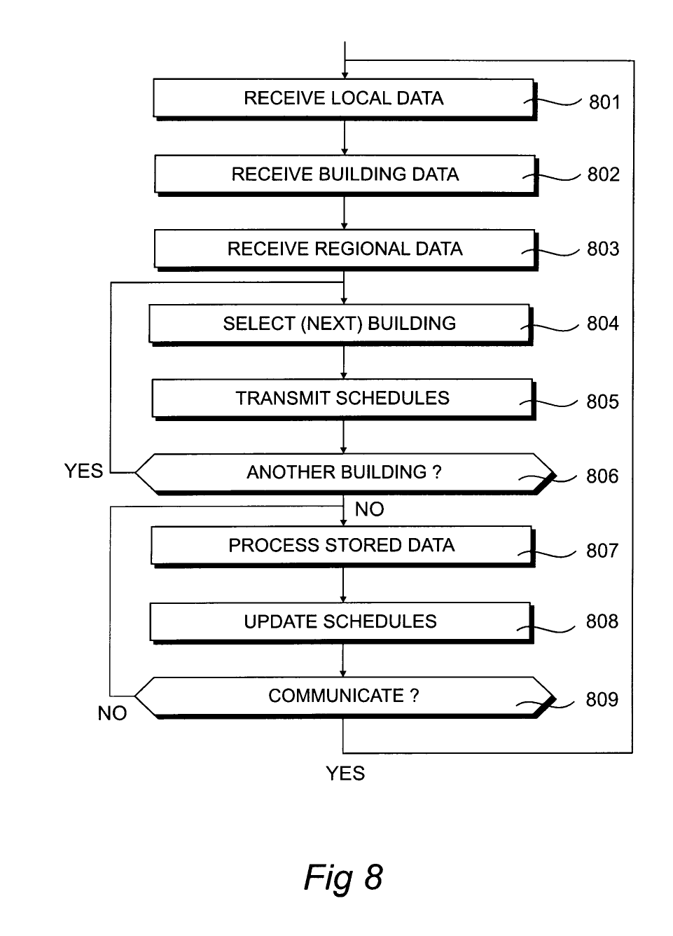

### FIG. 8

Procedures performed by the central control device 208 are shown in FIG. 8.

At step 801 local data is received, having been conveyed by the building control device 207.

At step 802 building related data is conveyed from the building control device and at step 803 regional data is received from source 211. Thus, by this stage, in this embodiment, the central control device has received all of the data that is currently available in order to facilitate the processing of this data and the generation of control schedules.

Having calculated control schedules or reading said schedules from memory, at step 804 a building is selected. Thereafter, at step 805 schedules are transmitted to the selected building control device (207). At step 806 a question is asked as to whether another building is to be considered and when answered in the affirmative control is returned to step 804.

When all of the buildings have been considered, the question asked at step 806 will be answered in the negative.

At step 807 stored data is processed and at step 808 schedules are updated.

At step 809 a question is asked at to whether communication is to take place and when answered in the negative control is returned to step 807; facilitating ongoing data processing and allowing the available resources to be used for enhanced data mining etc.

When the process is interrupted by a requirement to transmit data, the question asked at step 809 is answered in the affirmative and control is returned to step 801.

In an embodiment, it is possible to consider the discharging controls of each individual device within the system. A procedure for monitoring discharging activities records when devices are discharging over two minute intervals. In an embodiment, this data may be cached at the individual local control devices or at the building control device such that it can be called upon by the central control device 208 if required.

In an embodiment, a database may be used for communication between the central control device and the building control devices. A data synchronisation process may be provided to deal with requests from the central control device 208. This allows data entered in the database over a period of time to be read during a start-up process.

Thus, in an embodiment, the building control devices and the central control device communicate by writing to and reading from a database. When a request is sent by the central control device, it may place a request flag in a database table. The building control device will then pick this up, process it and put information back into another table in the database, whereafter the flag is reset.

Real-time operation of the system ensures that data is supplied to the building control device and conveyed to the central control device regularly and is kept updated. However, ongoing processing within the central control device does not require a real-time capability. Procedures conducted within the central control device 208 may be directed towards long term objectives of optimising power use.

An overall objective may be to optimise performance and thereby save energy. However, the system also aims to improve the services provided to end users and to extend the useful life of the installed equipment. The availability of sophisticated control systems of this type may also make a potentially non-viable off-peak heating system viable again in terms of overall energy consumption.

In addition to optimising energy use, the central control device 208 could also output indications of unusual characteristics, thereby allowing these characteristics to be analysed by a human operator. However, given that the majority of the operations and enhancements towards optimisation may occur automatically, it is possible for a single human operator to have responsibility for a large network; given that manual intervention would be a rare occurrence.

In an embodiment, forecasts and schedules are generated for the next three days and three days worth of data are transmitted to the building control devices. These schedules may be modified, in an embodiment, to take account of weather forecasts and expected demands.

If communication breaks down between the central control device and a building control device, data will have been received for up to three days of operation. Furthermore, if this data remains valid it does not need to be re-sent, even when the system is fully operational.

In an embodiment, it is possible for the building control device 207 to provide schedules to the local control devices without the intervention of the central control device 208. The building control device 207 could provide a degree of adaptive modelling or, alternatively, the building control device 207 could be provided with default factory preset values.

In an embodiment, it is possible to perform charge window shifting. If there is a seven hour charging window but the demand has been calculated at four hours, these four hours could be moved around or split, so as to balance the overall load. In some circumstances, it may be possible to obtain a lower tariff if the peak demand is kept below a specified level.

In an embodiment, hand controllers display ambient temperatures and allow a required temperature to be set. They may also be provided with a panic button which in turn generates a prioritised message going back to the building control device 207 and possibly back to the central control device 208. Residents vulnerable to hypothermia could be monitored to ensure that room temperatures do not drop below a specified value, such as 16° C. An identification of very high temperatures could also be investigated.

The system provides an environment in which it is possible to monitor buildings that are not regularly attended. Furthermore, the system could be integrated with other forms of heating present within the building thereby identifying further opportunities for waste reduction and optimising the use of renewable sources where available.

What we claim is:

1. Apparatus for heating a plurality of rooms in a plurality of buildings, comprising:
a plurality of electric storage heaters configured to receive off-peak electricity, generate thermal energy and store said thermal energy for later release; wherein
each said electric storage heater has a local control device configured to control thermal energy generation during the reception of said off-peak electricity, and to receive a generation schedule from a building control device; wherein said building control devices are configured to control a plurality of local control devices and to transmit information to a central control device;
said central control device is configured to transmit generation schedules to a plurality of building control devices, in which each said schedule is constructed in response to room-related data supplied to said local control devices, building related data supplied to said building control devices, and regional data supplied to said central control device.

2. The apparatus of claim 1, wherein a building comprises a plurality of dwellings and a plurality of said rooms make up a dwelling.

3. The apparatus of claim 1, wherein a local control device controls the release of stored thermal energy by the operation of opening devices.

4. The apparatus of claim 3, wherein the release of stored energy is also facilitated by the activation of an active fan.

5. The apparatus of claim 1, wherein a local control device receives local temperature data.

6. The apparatus of claim 5, wherein said temperature data represents the temperature of a heat storage material.

7. The apparatus of claim 5, wherein said temperature data represents room temperature.

8. The apparatus of claim 1, wherein said building related data identifies properties of heating and heat retention for regions of the building.

9. The apparatus of claim 1, wherein said building related data identifies heating and heat retention propertied for the building as a whole.

10. The apparatus of claim 1, wherein said regional data is weather-related data.

11. A method of controlling the amount of electrical energy supplied to electric storage heaters, comprising the steps of:
connecting each electric storage heater to a local control device;
supplying local data from each of a plurality of local control devices to a building control device;
conveying local data and building data from one or more building control devices to a central control device;
receiving regional data at said central control device;
transmitting schedules of activation from said central control device to said one or more building control devices; and
relaying individual activation schedules from said one or more building control devices to each of said local control devices, wherein each said schedule is constructed in response to room related data supplied from respective local control device, building related data supplied from building control devices, and regional data supplied to said central control device.

12. The method of claim 11, wherein communications within a building for supplying local data from each of a plurality of local control devices and for relaying individual activation schedules is conducted within a wireless environment.

13. The method of claim 11, wherein schedules are transmitted from the central control device to one or more building control devices for a plurality of days and individual activation schedules are relayed on a day by day basis.

14. The method of claim 11, wherein electric storage heater internal temperatures are analysed by said central control device in order to identify maximum heat capacities.

15. The method of claim 14, wherein said schedules are modified in order to reduce charge times in response to the calculation of said maximum heat capacities.

16. The method of claims 11, wherein charge times and/or discharge charge times are reduced in response to a failure to detect motion.

17. An electric storage heater configured to receive off-peak electricity, comprising:
an electric heater energised via a local control device in response to a generation schedule;
a heat storage material having a temperature sensor;
an insulated housing for retaining said heat storage material; and
a controllable opening for adjusting heat output, wherein
said local control device supplies local data to a building controller;
said local controller conveys local data from a plurality of local control devices and building data to a central control device;
said central control device receives regional data and transmits schedules of activation to one or more building control devices; and
said building control device relays individual activation schedules to the local control device.

18. A local control device for an electric storage heater, comprising:
a first output for supplying heating electricity to an electric storage heater;
a second output for controlling the release of stored heat from said electric storage heater; and
an input for receiving data defining a heat generation schedule.

19. The local control device of claim 18, including an override function to allow manual control.

20. The local control device of claim 18, including a sensor for detecting current flow when charging.
